(19) United States
(12) Patent Application Publication
(10) Pub. No.: US 2018/0224067 A1
(43) Pub. Date: Aug. 9, 2018

(54) REMOTE CONTROL OF A GAS-DISTRIBUTION FACILITY

(71) Applicants: L'Air Liquide, Société Anonyme pour L'Exploitation des Procédés Georges Claude, Paris (FR); Air Liquide Electronics Systems, Paris (FR)

(72) Inventors: Aziz OUERD, Grenoble (FR); Henrique DOS REIS, Polienas (FR); Hervé DULPHY, Jarrie (FR)

(73) Assignees: L'Air Liquide, Société Anonyme pour L'Exploitation des Procédés Georges Claude, Paris (FR); Air Liquide Electronics Systems, Paris (FR)

(21) Appl. No.: 15/749,050

(22) PCT Filed: Jul. 20, 2016
(86) PCT No.: PCT/FR2016/051878

§ 371 Date: Jan. 30, 2018

(30) Foreign Application Priority Data
Jul. 31, 2015 (FR) 1557389

(51) Int. Cl. F17C 13/02; G05B 19/05

(52) U.S. Cl. CPC F17C 13/02; G05B 19/058; F17C 2223/0123; F17C 2223/0153; G05B 2219/25167; F17C 2250/034; F17C 2270/0518; G05B 2219/15117; F17C 2223/03

(57) ABSTRACT

A gas distribution installation including a housing designed to receive at least one gas cylinder and having a gas input opening and a gas output opening; a system of gas ducts arranged in the housing to which the at least one gas cylinder is connected; a gas distribution system linked to the output opening allowing an equipment item to be supplied, and at least one communication port and a programmable logic controller, the logic controller being provided with a processor capable of processing data originating at least partly from a portable data storage and processing system distinct from the installation and wherein the data originating at least partly from a portable data storage and processing system distinct from the installation are used to manage control and/or maintenance parameters of the gas distribution system.

### CROSS REFERENCE TO RELATED APPLICATIONS

This application is a 371 of International Patent Application PCT/FR2016/051878, filed Jul. 20, 2016, which claims priority to French Patent Application 1557389, filed Jul. 31, 2015, the entire contents of which are incorporated herein by reference.

### BACKGROUND

The present invention relates to the use of a data storage and processing system for remotely controlling a gas cabinet.

A gas cabinet should be understood to be a gas distribution installation.

A gas cabinet is a device for distributing specialty gases (ESG) for use in specific and one-off applications in different industries such as semiconductor, photovoltaic, LED and flat screen industries or any other industry such as mining or pharmaceutical industries.

The implementation of these methods often requires the use of hazardous gases of high quality demanding, for example, automatic bleeds and continuous distribution. For example, the fabrication of electronic circuits requires the use of various so-called “working” gases such as, for example, Cl₂, NH₃, HCl, HBr, NF₃ or WF₆, etc., which are, for the most part, considered hazardous to human beings because of their toxicity and/or their flammability.

Many industrial installations require equipment capable of automatically controlling the supply of gases and fluids to certain equipment items. For example, the fabrication of integrated circuits generally includes several methods such as, for example, vapor phase deposition in which a variety of gases are brought into a reaction chamber in which a semiconductor substrate is confined. The temperature and the pressure of deposition of the various layers of materials developed to create the three-dimensional models of integrated circuits are carefully controlled in this enclosure.

All the substances transported into and out of the reaction chamber have to be constantly monitored, since the proportions of the different reagents which make up the vapor atmosphere ultimately determine the physical dimensions of the elements which will collectively make up a single and vast electrical circuit on a minuscule piece of silicon, in particular transistors, capacitors and resistors.

One of the greatest causes of malfunctioning of the integrated circuits can be attributed to the microscopic dust particles which contaminate the working zone where the circuit is fabricated. A minuscule foreign body can damage a very expensive circuit and make it unusable. In order to safeguard against such particulate contamination, the manufacturers of semiconductors fabricate their products in a protected “clean room” environment.

The air taken into a clean room is first of all filtered, thus almost entirely eliminating the undesirable particles of dust. The technicians who work in these environments wear special clothing and masks which prevent the introduction of substances which would damage their meticulous work. The costs linked to the maintenance and the correct operation of this greatly specialized environment are considerable. Consequently, all the space of a clean room must be used in the most efficient way possible.

In addition to this critical need, the chemical products used must be distributed with great care. The liquid chemical products and the specialty gases used in the semiconductor industry are often toxic. The devices chosen to distribute these potentially hazardous products must ensure reliable use, protected from corrosion or leakage.

In a conventional gas distribution system, large volumes of gases to be bled, that are potentially hazardous, create safety problems. The piping and precision setting assemblies are also liable to leaks or to serious damage during use. These installations are therefore not suited to one-off uses requiring frequent disconnections and bleeds multiplying the risks for the operator of being exposed to hazardous gases.

These standard gas cabinets are primarily for everyday and reliable use in long term production and distribution applications. These systems are installed entirely in large cabinets in dedicated rooms that can be located several tens of meters from the equipment item to which they are connected.

The standard gas cabinets comprise a “human-machine interface” connected to a programmable logic controller used to control, that is to say, to monitor and manage the maintenance of the gas distribution system of said gas cabinet.

This human-machine interface for example has a touchscreen of a size greater than or equal to 10 inches allowing the user to give these instructions to the logic controller directly from this screen.

This operation can prove tedious to the user who is obliged to go to the gas cabinet and can therefore control the gas cabinet only from the screen incorporated in said cabinet. In other words, there are as many human-machine interfaces as there are gas cabinets to be controlled. This constitutes a time-wasting constraint but also a constraint on the bulk of gas cabinet to be controlled which necessarily has to be provided with a screen that is large enough to show all the parameters to be monitored and/or controlled to control the gas distribution system.

There is therefore a need to minimize the cost, the bulk and the number of components while retaining the necessary functionalities of the gas cabinets in the fields of application mentioned above.

### SUMMARY

This is why the subject of the present invention is a gas distribution installation comprising:

a housing suitable for receiving at least one gas cylinder and having a gas input opening and a gas output opening;

a system of gas ducts arranged in said housing to which said at least one gas cylinder is connected;

a gas distribution system linked to said output opening allowing an equipment item to be supplied,

characterized in that it comprises at least one communication port and a programmable logic controller, said logic controller being provided with a processor capable of processing data originating at least partly from a portable data storage and processing system distinct from the installation.

According to other particular embodiments, other subjects of the invention are:

the installation as defined above characterized in that said communication port is chosen from among a wireless transceiver, an Ethernet port, a cellular radio transceiver, a WIFI transceiver and a Bluetooth transceiver.

The installation as defined above characterized in that it further comprises a human-machine interface connected to said logic controller.

The installation as defined above, characterized in that said interface comprises a touchscreen whose size is less than or equal to twelve inches, preferably less than six inches.

The installation as defined above, characterized in that said housing contains two gas cylinders.

The installation as defined above, characterized in that said logic controller is controlled by a portable data storage and processing system distinct from the installation chosen from among a tablet, an intelligent telephone such as a smartphone, a laptop computer.

The installation as defined above, characterized in that the data originating at least partly from a portable data storage and processing system distinct from the installation are used to manage control and/or maintenance parameters of said gas distribution system such as:

the opening or the closing of valves included in said system of ducts,

the launching of a bleed cycle,

gas distribution,

the management of the pressure and/or of the temperature of said gas distribution system,

the heating of said at least one gas cylinder.

A method for exchanging maintenance and/or control data of a specialty gas distribution system between at least one installation as defined above and a portable data storage and processing system distinct from the installation chosen from among a tablet, an intelligent telephone such as a smartphone, a laptop computer, comprising the step of transmission of data by a wireless connection such as a WIFI or Bluetooth connection or a connection set up by Ethernet cable.

The method as defined above, characterized in that the exchange of data is set up between a portable data storage and processing system distinct from the installation chosen from among a tablet, an intelligent telephone such as a smartphone, a laptop computer and a number of installations as defined above lying between 2 and 20.

The data storage and processing system for controlling a gas cabinet implemented for the present invention can take the form of a tablet, a smartphone, a laptop computer when a maintenance or even everyday use operation is envisaged, or a desktop computer.

### DESCRIPTION OF PREFERRED EMBODIMENTS

Advantageously, said smartphone duplicates the views of the human-machine interface and is therefore used for everyday operations. The other devices can be used both for the everyday operations and for maintenance.

This system is associated with a human-machine interface (HMI) and with a programmable logic controller of small sizes installed on the cabinet. It therefore contains a series of parameters which no longer appear on the new HMI and a diagram of the method and of the instrumentation which make it possible both to control the components (open a valve, launch a gas bleed or distribution sequence), but also make it possible to access functions that cannot be accessed on the HMI, such as the parameters of the pressure and temperature sensors, as well as advanced option parameters, such as those of the AVP (All Vapor Phase) of the resistive heating of the cylinders when the gas distributed is in liquefied form. It is connected to the gas cabinet either through a wireless network (WIFI), or through a network (Ethernet) cable.

Since the same data storage and processing system can be used to control several gas cabinets, an identification code is associated with each of the gas cabinets located on the facility of the user to ensure that said data storage and processing system communicates only with the gas cabinet on which the user wants to intervene.

Moreover, and for safety reasons, a physical locking (using a key for example) of the communication between this data storage and processing system and the gas cabinet is put in place.

Another application of the use of an intelligent telephone (smartphone), of a tablet or of a laptop computer for controlling a gas cabinet, particularly during maintenance operations according to the present invention, can for example be the duplication of the mimic diagrams of the HMI (human-machine interface) and therefore the performance of the same operations that can be performed with the latter.

A gas cabinet implemented according to the present invention comprises a housing with a rear wall, sidewalls, a front wall, a bottom, and a ceiling. In the housing, two gas cylinders are provided which stand on the bottom and are fixed in the housing in a manner known from the prior art. The two gas cylinders are positioned in such a way that a minimal gap is present between the two and they contain gases supplied in a known way to a consumer. The gas cylinders can, optionally, each have a gas valve by which they are linked to a system of gas ducts. The system of gas ducts has two duct branches connected to a common output line. The two duct branches can be closed, for example, by a valve, respectively, in relation to the output line. During the operation of the gas cabinet, advantageously, just one of the two gas cylinders is being used. The duct branches of the other gas cylinder then being closed, for example, by the valve of the output line. The gas cabinet can also have a single gas cylinder or more than two gas cylinders.

Specialty gases should be understood to include all the gases generally used in the semiconductor industry. They can be inert, toxic, corrosive or pyrophoric gases. These specialty gases can be chosen from among: HF, WF6, BCl3, ClF3, DCS, 3MS, C4F6, C4F8O, C4F8, butane, SO2, Cl2, C3F8, NH3, propane, SF6, HBr, C2F6, CH3F, HCl, CHF3, N2O contained in a cylinder in liquefied form, or even from among F2, PH3, B2H6, NO, NF3, SiH4, CF4, CH4, CO contained in the cylinder in compressed form. Thus, depending on the nature of the gas to be distributed and its state, liquefied or compressed, the pressure inside the cylinder lies between 0 bar and 200 bar.

All the components used conform to the semiconductor industry standard.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-8. (canceled)

9. A gas distribution installation comprising:
i. a housing configured to receive at least one gas cylinder and having a gas input opening and a gas output opening;
ii. a system of gas ducts arranged in the housing to which the at least one gas cylinder is connected;
iii. a gas distribution system linked to the output opening allowing an equipment item to be supplied,
further comprising at least one communication port and a programmable logic controller, the logic controller being provided with a processor capable of processing data originating at least partly from a portable data storage and processing system distinct from the installation and wherein the data originating at least partly from a portable data storage and processing system distinct from the installation are used to manage control and/or maintenance parameters of the gas distribution system such as:
the opening or the closing of valves included in the system of ducts,
the launching of a bleed cycle,
gas distribution,
the management of the pressure and/or of the temperature of the gas distribution system,
the heating of the at least one gas cylinder.

10. The installation of claim 1, wherein the communication port is selected from the group consisting of a wireless transceiver, an Ethernet port, a cellular radio transceiver, a WIFI transceiver and a Bluetooth transceiver.

11. The installation of claim 9, further comprising a human-machine interface connected to the logic controller.

12. The installation of claim 11, wherein the interface comprises a touchscreen whose size is less than or equal to twelve inches.

13. The installation of claim 9, wherein the housing contains two gas cylinders.

14. The installation of claim 9, wherein the logic controller is controlled by a portable data storage and processing system distinct from the gas installation chosen from among a tablet, an intelligent telephone such as a smartphone, a laptop computer.

15. A method for exchanging maintenance and/or control data of a specialty gas distribution system between at least one installation as defined in claim 9 and a portable data storage and processing system distinct from the installation chosen from among a tablet, an intelligent telephone such as a smartphone, a laptop computer, comprising the step of transmission of data by a wireless connection such as a WIFI or Bluetooth connection or a connection set up by Ethernet cable.
